(19) United States
(12) Patent Application Publication
(10) Pub. No.: US 2010/0289532 A1
(43) Pub. Date: Nov. 18, 2010

(54) ADAPTATION CIRCUIT FOR CONTROLLING A CONVERSION CIRCUIT

(75) Inventors: Matthias Wendt, Eindhoven (NL); Heinz W. Van Der Broeck, Eindhoven (NL); Georg Sauerländer, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N V, Eindhoven (NL)

(21) Appl. No.: 12/377,503

(22) PCT Filed: Aug. 30, 2007
(86) PCT No.: PCT/IB2007/053501

§ 371 Date: Jul. 22, 2010

(30) Foreign Application Priority Data
Sep. 8, 2006 (EP) 06120336.0

(51) Int. Cl. H02M 1/00

(52) U.S. Cl. 327/103

(57) ABSTRACT

Adaptation circuits (3) for controlling conversion circuits (1-2) for converting input signals into pulse signals and for converting pulse signals into output signals are provided with generators (30) for generating control signals in dependence of input signals and (basic idea) with compensation circuits (71-72, 81-83) for adjusting the generators (30) in dependence of input information for increasing a stability of output signals, to be able to supply relatively constant output signals to loads (6). The adaptation circuits (3) may reduce dependencies between input signals and output signals and may generate control signals independently from output signals to avoid feedback loops. Input signals may be input voltages, output signals may be output currents, and input information may comprise input voltages and nominal input voltages for compensating for variations of input voltages or may comprise nominal output voltages and input currents proportional to output voltages for compensating for variations of output voltages.

The invention relates to an adaptation circuit for controlling a conversion circuit, and also relates to a supply circuit comprising an adaptation circuit and a conversion circuit, to a device comprising a supply circuit, to a method and to a computer program product.

Examples of such a conversion circuit are power conversion circuits, without excluding other conversion circuits. Examples of such a supply circuit are switched mode power supplies, without excluding other supply circuits. Examples of such a device are consumer products and non-consumer products, without excluding other products.

WO 2005/036726 A1 discloses a control circuit, a DC/AC inverter (conversion circuit), a power converter (supply circuit) comprising the DC/AC inverter and the control circuit, and a liquid crystal display (device) comprising a power converter. In WO 2005/036726 A1, the control circuit for controlling the DC/AC inverter forms part of this DC/AC inverter and is coupled to a further control circuit (logical circuitry) that directly controls the gates of the transistors of the DC/AC inverter.

It is an object of the invention, inter alia, to provide an adaptation circuit for controlling a conversion circuit for supplying a relatively constant output signal to a load.

Further objects of the invention are, inter alia, to provide a supply circuit comprising an adaptation circuit and a conversion circuit, to a device comprising a supply circuit, to a method and to a computer program product, for supplying a relatively constant output signal to a load.

The adaptation circuit for controlling a conversion circuit for converting an input signal into a pulse signal and for converting the pulse signal into an output signal is defined by comprising
an input for receiving the input signal,
a generator for generating a control signal in dependence of the input signal,
an output for supplying the control signal to the conversion circuit, and
a compensation circuit for adjusting the generator in dependence of input information for increasing a stability of the output signal.

The adaptation circuit controls the power conversion circuit. The power conversion circuit converts the input signal into the pulse signal and then converts the pulse signal into the output signal. The generator generates the control signal for said control of the power conversion circuit. By introducing, in addition to the generator, the compensation circuit that adjusts the generator in dependence of the input information for increasing a stability of the output signal, the power conversion circuit can supply a relatively constant output signal to a load.

An embodiment of the adaptation circuit according to the invention is defined by claim 2. The adaptation circuit reduces a dependency between the input signal and the output signal and generates the control signal independently from the output signal. This embodiment advantageously avoids a use of a disadvantageous feedback loop from the secondary side of the power conversion circuit to the primary side of the power conversion circuit. In other words, this embodiment supplies the control signal in dependence of a primary side signal and independently from a secondary side signal.

An embodiment of the adaptation circuit according to the invention is defined by claim 3. The input signal is an input voltage and the output signal is an output current and the input information comprises the input voltage and a nominal input voltage for compensating for variations of the input voltage. The control of the power conversion circuit further for example reduces a dependency between for example an output voltage and for example the output current.

An embodiment of the adaptation circuit according to the invention is defined by claim 4. This embodiment concerns a compensation of an offset current caused by variations of the input voltage. To compensate the offset current, the input voltage is to be compared with a nominal input voltage, and the resulting difference is to be weighted and supplied to the generator. If the input voltage increases, a frequency of the pulse signal will be slightly decreased and vice versa. As a result, the offset current can be compensated. The compensation effect has to be adjusted by an amplifier factor k1 (a weighting factor). The optimal value for k1 depends on losses in the power conversion circuit.

An embodiment of the adaptation circuit according to the invention is defined by claim 5. The input signal is an input voltage and the output signal is an output current and the input information comprises a nominal output voltage and an input current proportional to an output voltage for compensating for variations of the output voltage. The control of the power conversion circuit further for example reduces a dependency between for example an output voltage and for example the output current.

An embodiment of the adaptation circuit according to the invention is defined by claim 6. This embodiment concerns a compensation of the offset current caused by variation of the output voltage. The output voltage can be detected in an unfiltered input current. This input current is composed of two positive half sine waves and can easily be measured by a ground-referenced shunt. The amplitude of the input current is directly proportional to the output voltage. Thus, by for example using a peak detector for the input current, the output voltage is virtually measured. The peak detected input current is to be compared with a nominal output voltage, and the resulting difference is to be weighted and supplied to the generator. As a result, again, the offset current can be compensated. The compensation effect has to be adjusted by an amplifier factor k2 (a weighting factor). The optimal value for k2 depends on losses in the power conversion circuit.

The supply circuit as defined by claim 7 comprises the adaptation circuit and comprises the power conversion circuit. Preferably, for such a supply circuit, the pulse signal comprises first pulses having a first amplitude and comprises second pulses having a second amplitude different from the first amplitude and comprises levels having a third amplitude different from the first and second amplitudes, the first amplitude being a positive amplitude, the second amplitude being a negative amplitude, and the third amplitude being a substantially zero amplitude, and the conversion circuit comprises first and second and third and fourth transistors and logical circuitry for receiving the control signal for bringing the first and fourth transistors in a conducting state to create the first pulses and for bringing the second and third transistors in a conducting state to create the second pulses and for bringing either the first and third or the second and fourth transistors in a conducting state to create the levels.

Then, a pulse signal with three different amplitudes is introduced to increase a number of controlling options. A symmetrical pulse signal is introduced, and four transistors in for example a full bridge configuration (H-bridge) are introduced. The logical circuitry couples the power conversion circuit and the adaptation circuit to each other.

Preferably, the power conversion circuit comprises a transformer or an inductor, a rectifying circuit comprising one or more output diodes coupled to a secondary side of the transformer or the inductor, and a capacitor coupled serially to a primary side or to a secondary side of the transformer or the inductor. The transformer provides galvanic isolation. The capacitor creates, in combination with the leakage inductance of the transformer and/or in combination with the inductor and/or in combination with a separate inductor, a resonant network having a resonant period/frequency.

Further preferably, the power conversion circuit comprises a resonant period and the pulse signal comprises a pulse having a pulse width substantially equal to half the resonant period, and/or the power conversion circuit comprises a resonant frequency and the pulse signal comprises pulses having a pulse frequency substantially equal to or smaller than half the resonant frequency, a product of the input signal and the pulse frequency being substantially constant.

The device as defined by claim 8 comprises the supply circuit and further comprises a load for receiving the output signal. The load for example comprises one or more light emitting diodes or LEDs.

Embodiments of the supply circuit and of the device and of the method and of the computer program product (and of a medium for storing and comprising a computer program product) correspond with the embodiments of the adaptation circuit.

An insight might be, inter alia, that a fluctuation in an input voltage may result in a fluctuation in an output current which is to be avoided.

A basic idea might be, inter alia, that in addition to a generator, a compensation circuit is to be introduced that adjusts the generator in dependence of the input information for increasing a stability of the output signal.

A problem, inter alia, to provide an adaptation circuit for controlling a power conversion circuit that can supply a relatively constant output signal to a load is solved.

These and other aspects of the invention will be apparent from and elucidated with reference to the embodiments(s) described hereinafter.

In the drawings:

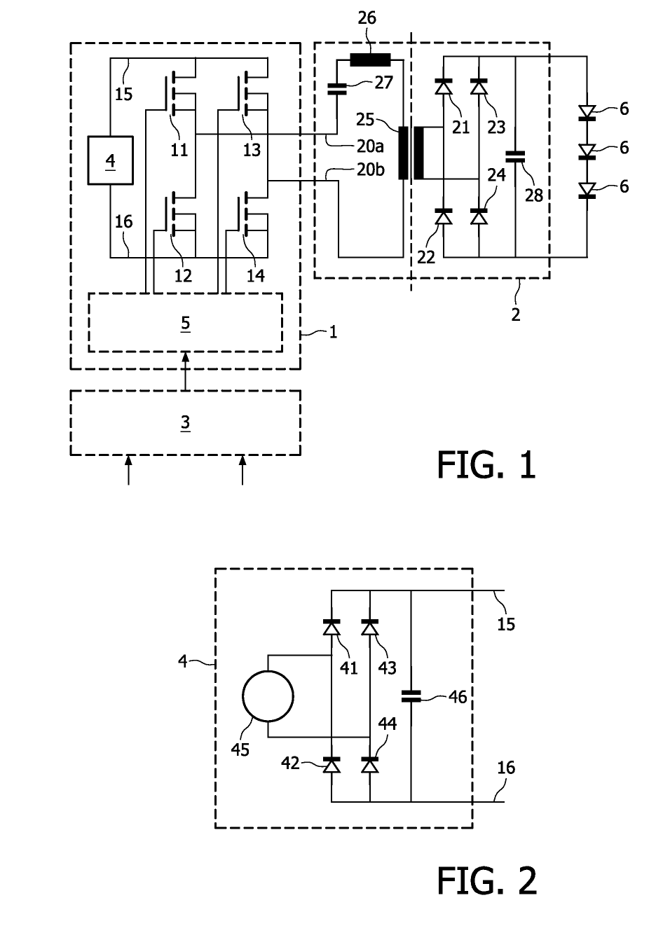

FIG. 1 shows diagrammatically a supply circuit according to the invention comprising an adaptation circuit according to the invention and a power conversion circuit,

FIG. 2 shows diagrammatically an AC to DC converter,

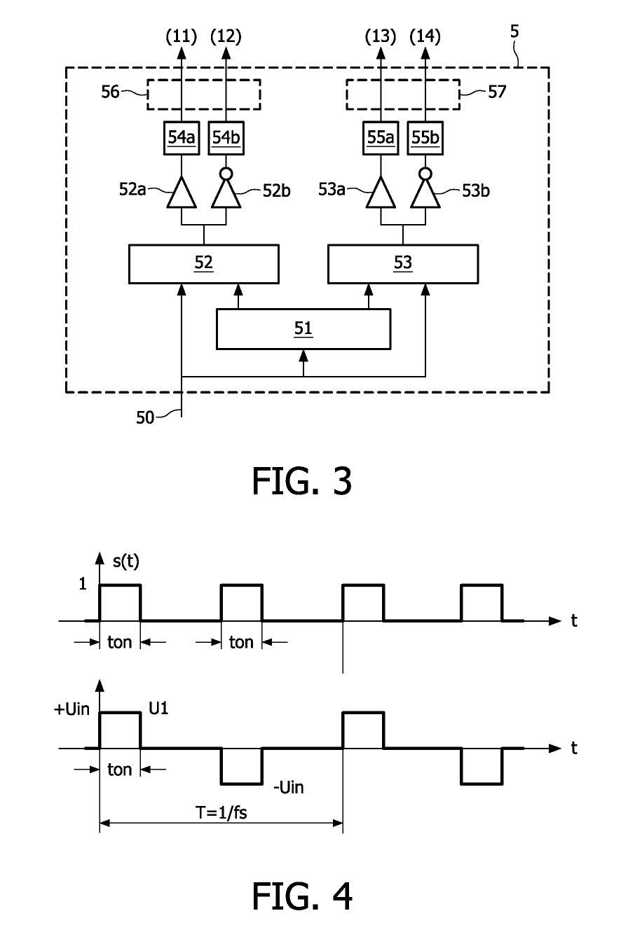

FIG. 3 shows logical circuitry for a power conversion circuit,

FIG. 4 shows a control signal and a pulse signal,

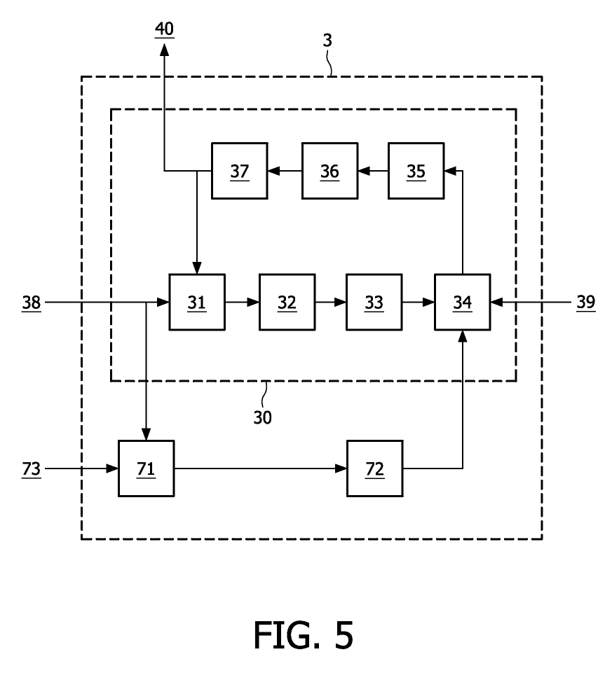

FIG. 5 shows a first embodiment of an adaptation circuit,

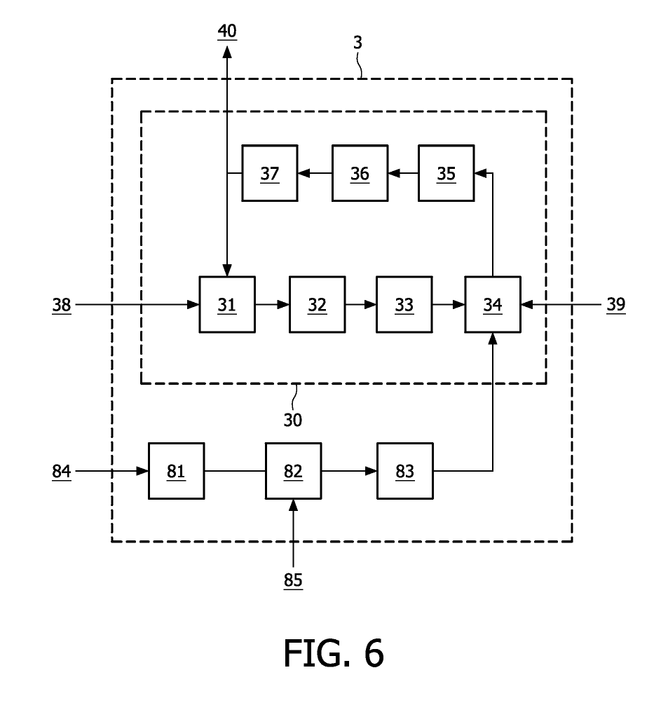

FIG. 6 shows a second embodiment of an adaptation circuit,

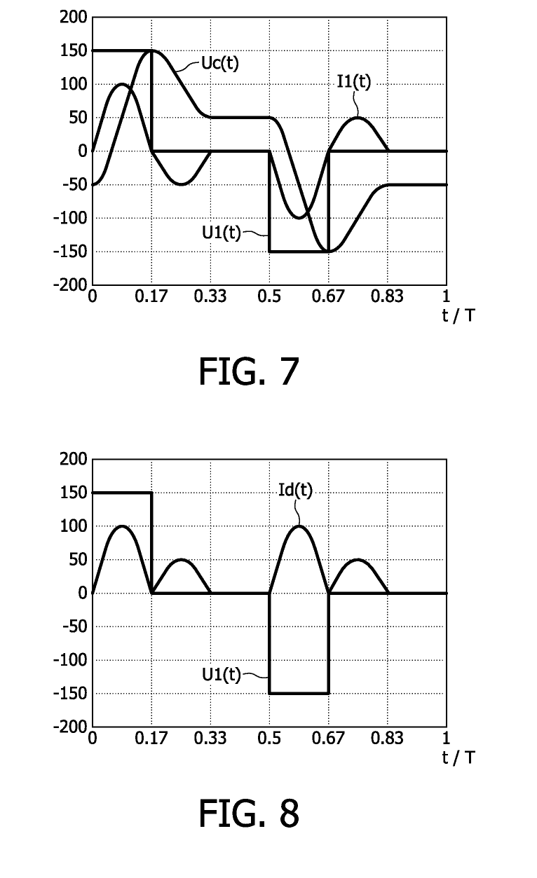

FIG. 7 shows a voltage across a capacitor and a current through this capacitor at a primary side of the power conversion circuit as a function of a pulse signal,

FIG. 8 shows an output current as a function of a pulse signal,

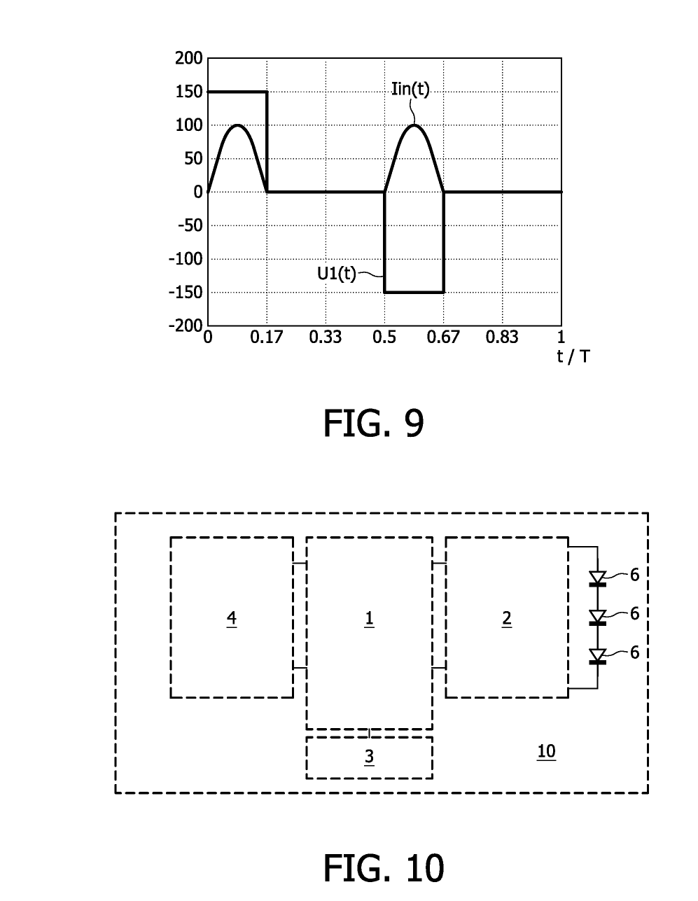

FIG. 9 shows an input current as a function of a pulse signal, and

FIG. 10 shows a device according to the invention.

The supply circuit 1-3 according to the invention shown in FIG. 1 comprises a power conversion circuit 1-2 and an adaptation circuit 3. The power conversion circuit 1-2 comprises a first circuit 1 and a second circuit 2. The first circuit 1 comprises a voltage source 4 for generating an input voltage Uin via first and second reference terminals 15 and 16. The first circuit 1 further comprises four transistors 11-14. A first transistor 11 has a first main electrode coupled to the first reference terminal 15 and has a second main electrode coupled to a first input 20a of the second circuit 2. A second transistor 12 has a first main electrode coupled to the second main electrode of the first transistor 11 and has a second main electrode coupled to the second reference terminal 16. A third transistor 13 has a first main electrode coupled to the first reference terminal 15 and has a second main electrode coupled to a second input 20b of the second circuit 2. A fourth transistor 14 has a first main electrode coupled to the second main electrode of the third transistor 13 and has a second main electrode coupled to the second reference terminal 16. The first circuit 1 further comprises logical circuitry 5 coupled to the adaptation circuit 3 and to the control electrodes of the transistors 11-14. This logical circuitry 5 will be discussed referring to FIG. 3.

The second circuit 2 comprises from the input 20a to the input 20b a serial resonance circuit of a capacitor 27, an inductance 26 and a primary side of a transformer 25. The inductance 26 is usually at least partly formed by a stray inductance of the transformer 25. The second circuit 2 further comprises four output diodes 21-24 coupled to a secondary side of the transformer 25 and forming a rectifying circuit that is further coupled to a smoothing capacitor 28 and to a load 6 for example comprising three serial light emitting diodes or LEDs.

The AC to DC converter 4 or voltage source 4 shown in FIG. 2 comprises an AC voltage source 45 coupled to four diodes forming a further rectifying circuit that is further coupled to a further smoothing capacitor 46.

The logical circuitry 5 shown in FIG. 3 comprises a flipflop 51 receiving the control signal s(t) from the adaptation circuit 3 at an input 50 of the logical circuitry 5. A Q-output of the flipflop is coupled to an AND gate 52 that further receives the control signal s(t) and an inverted Q-output of the flipflop 51 is coupled to an AND gate 53 that further receives the control signal s(t). An output of the AND gate 52 is coupled via a non-inverter 52a to a tdon delay circuit 54a and via an inverter 52b to a tdon delay circuit 54b. An output of the AND gate 53 is coupled via a non-inverter 53a to a tdon delay circuit 55a and via an inverter 53b to a tdon delay circuit 55b. The respective tdon delay circuits 54a and 54b and 55a and 55b are coupled to the control electrodes of the respective transistors 11-14, possibly via a level shifter 56 on behalf of the transistors 11 and 12 and a level shifter 57 on behalf of the transistors 13 and 14.

In FIG. 4, a control signal s(t) and a pulse signal U1(t) resulting from the control signal s(t) are shown. The pulse signal U1(t) has first pulses having a first amplitude +Uin and has second pulses having a second amplitude −Uin different from the first amplitude and has levels having a third amplitude 0 different from the first and second amplitudes. Preferably, the first amplitude is a positive amplitude, the second amplitude is a negative amplitude, and the third amplitude is a substantially zero amplitude. The pulse signal U1(t) is for example present between the inputs 20a and 20b.

The adaptation circuit 3 shown in FIG. 5 (first embodiment) comprises a (pulse) generator 30 with an input 38 for receiving the input voltage Uin (more general: input signal or primary side signal) and with an output 40 to be coupled to the input 50 for supplying the control signal s(t) to the logical circuitry 5 in dependence of the input voltage Uin and independently from the output voltage at the load 6. The generator 30 further comprises a further input 39 for receiving a reference current (for dimming purposes), the control signal s(t) further depending on the reference current. Thereto, the generator 30 comprises a multiplier 31 for multiplying the input voltage Uin and the control signal s(t) and comprises a low pass filter 32 for low pass filtering a multiplier output voltage and comprises a converter 33 for converting a low pass filter output voltage into a proportional estimated output current value and comprises a unit 34 for determining a difference between the reference current and the estimated output current (by subtraction, or by adding for example the reference current to an inversion of the estimated output current). The generator 30 further comprises a controller 35 for receiving the difference of the current values and comprises a voltage controlled oscillator 36 for receiving a controller output signal and comprises a monoflop 37 for receiving a voltage controlled oscillator output signal and for generating the control signal s(t).

The adaptation circuit 3 further comprises a yet further input 73 for receiving a nominal input voltage Uin0 and comprises a unit 71 coupled to the inputs 38 and 73 for determining a difference between the nominal input voltage Uin0 and the given input voltage Uin (by subtraction, or by adding for example the nominal input voltage Uin0 to an inversion of the input voltage Uin). A multiplying unit 72 multiplies the difference with a first weighting factor k1 and supplies a weighted difference between the nominal input voltage Uin0 and the input voltage Uin to the unit 34 for being added to the difference between the reference current and the estimated low pass filter output current.

This way, a compensation circuit 71-72 comprising the units 71 and 72 adjusts the generator 30 in dependence of input information in the form of (a difference between) an input voltage Uin and a nominal input voltage Uin0 for increasing a stability of an output signal in the form of an output current Tout through the load 6. This embodiment concerns a compensation of an offset current caused by variations of the input voltage Uin. To compensate the offset current, the input voltage Uin is to be compared with a nominal input voltage Uin0, and the resulting difference is to be weighted and added to the generator 30. If the input voltage Uin increases, a frequency of the pulse signal will be slightly decreased and vice versa. As a result, the offset current can be compensated. The compensation effect is adjusted by a weighting factor k1 that depends on losses in the power conversion circuit 1-2.

The adaptation circuit 3 shown in FIG. 6 (second embodiment) corresponds with the one shown in the FIG. 5, apart from the following. Instead of the units 71 and 72 and the yet further input 73, the adaptation circuit 3 comprises another input 84 for receiving an input current Iin flowing through the voltage source 4 and comprises a peak detecting unit 81 coupled to the other input 84 for receiving and performing a peak detection on the input current Iin. This peak detected input current is proportional to an output voltage Uout, and a unit 82 determines a difference between this estimated output voltage Uout and a nominal output voltage Uout0 arriving via a yet other input 85 (by subtraction, or by adding for example the output voltage Uout and an inverted version of the nominal output voltage Uout0). A multiplying unit 83 multiplies this difference with a second weighting factor k2 and supplies a weighted difference between the estimated output voltage Uout and the nominal output voltage Uout0 to the unit 34 for being added to the difference between the reference current and the estimated output current.

This way, a compensation circuit 81-83 comprising the units 81, 82 and 83 adjusts the generator 30 in dependence of input information comprising (a difference between) a nominal output voltage Uout0 and a peak detected input current Iin for increasing a stability of an output signal in the form of an output current Tout through the load 6. This embodiment concerns a compensation of the offset current caused by variation of the output voltage Uout. The output voltage Uout can be detected in an unfiltered input current. This input current Iin is composed of two positive half sine waves and can easily be measured by a ground-referenced shunt. The amplitude of the input current Iin is directly proportional to the output voltage Uout. Thus, by for example using a peak detector for peak detecting the input current Iin, the output voltage Uout is virtually measured. The peak detected input current is to be compared with a nominal output voltage Uout0, and the resulting difference is to be weighted and added to the generator 30. As a result, again, the offset current can be compensated. The compensation effect is adjusted by a weighting factor k2 that depends on losses in the conversion circuit 1-2.

In FIG. 7, a voltage Uc(t) across a capacitor 27 and a current I1(t) through this capacitor 27 at a primary side of the power conversion circuit 1-2 are shown as a function of a pulse signal U1(t).

In FIG. 8, an output current Id(t) being the transformer scaled and rectified current at a secondary side of the power conversion circuit 1-2 is shown as a function of a pulse signal U1(t).

In FIG. 9, an input current Iin(t) flowing through a voltage source 4 at a primary side of the power conversion circuit 1-2 is shown as a function of a pulse signal U1(t).

The device 10 according to the invention shown in FIG. 10 comprises the power conversion circuit 1-2 and the adaptation circuit 3 and the load 6 and the voltage source 4 this time located outside the power conversion circuit 1-2.

In general, a galvanic isolating driver topology and a control scheme for Light Emitting Diodes or LEDs have been created. The input voltage Uin can be a non-stabilized DC voltage. The driver consists of a transistor H-bridge 11-14, an adaptation circuit 3 for the H-bridge 11-14, a transformer 25, a series capacitor 27, a diode bridge 21-24 and a smoothing output capacitor 28. At the output, a series connection of LEDs can be supplied.

The transformer 25 serves for galvanic isolation and may adapt the voltage level, e.g. from 300V to 30V. A resonant topology is formed by the stray inductance 26 of the transformer 25 and the series capacitor 27. Thus, the parasitic leakage inductance of the transformer 25 can be part of the driver. Contrary to Pulse Width Modulation based converters such as forward or fly back topologies, here the leakage inductance does not need to be minimized. This is of advantage for the isolation and winding design and it thus keeps the cost low. The leakage inductance can also be extended by an additional choke.

The adaptation circuit 3 and the logical circuitry 5 generate alternated positive and negative voltage pulses with a fixed pulse width. Between these voltage pulses the H-bridge 11-14 should stay in a free wheel state for a settable time. Hence, the output is controlled by the repetition frequency. If the resonant frequency of the circuit is properly adapted to the width of the voltage pulse and if the number of LEDs meets the operation voltage range of the circuit, an ideal LED supply driver has been created that shows the following features:
The current in the driver becomes sinusoidal and it is zero at the switching instants. This avoids switching losses and minimizes EMI.
The average current in the LEDs is proportional to the DC input voltage of the driver and to the operating frequency. This means the voltage drops of the LEDs do not affect the current over a large load range. If the product of the DC input voltage times the frequency is kept constant, the average current in the LEDs is constant as well. Moreover the LED current can be varied from a nominal value down to zero.
The LED driver system neither requires sensors nor control units on the secondary (LED) side.
Changes of the LED parameters do not affect the current in the LEDs.
   This also includes a short circuit of a single LED. The overall voltage drop of all LEDs may vary between 33% and 100%.
The nominal output voltage can be set by the turn ratio of the transformer 25.
The lighting system is very suitable for mains supply.
A dimming function can easily be installed.

The power and control unit can be integrated in a smart power IC.

More in particular, any none stabilized DC voltage Uin can be used to supply the driver. This voltage may be generated from the AC mains by using a further diode bridge 41-44 and a further smoothing capacitor 46. The power part of the driver consists of an H-bridge realized by 4 transistors 11-14. These transistors 11-14 are controlled by the adaptation circuit 3 via the logical circuitry 5. Voltage level shifters may be used as interfaces between the control electrodes of the transistors 11-14 and the logical circuitry 5.

The output terminals of the H-bridge 11-14 are connected to the primary winding of the transformer 25 via a series capacitor 27. The secondary winding of the transformer 25 feeds the diode bridge 21-24. This diode bridge 21-24 rectifies the AC voltage from the transformer 25 and a smoothing capacitor 28 is used to smooth the output voltage Uout. The series connection of an arbitrary number of LEDs is supplied by the output voltage Uout.

The series capacitor 27 and the stray inductance 26 of the transformer 25 form a series resonant circuit with a resonant frequency fres=(2π)⁻¹(L₂₆C₂₇)^{-1/2}=(Tres)⁻¹ and with a resonant impedance Zres=(L₂₆/C₂₇)^{-1/2}. The H-bridge 11-14 generates alternately positive and negative voltage pulses (+Uin or −Uin). The positive voltage pulse occurs if transistor 11 and transistor 14 are in the on state while the negative voltage pulse can be set turning on the transistors 12 and 13. Between the voltage pulses the H-bridge 11-14 provides a free wheel path, which may be performed either by turning on 11 and 13 or by turning on 12 and 14. The time width ton of the positive and negative pulses are preferably set equal to half the resonant period ton=Tres/2, without excluding other settings.

In case the pulse width ton is fixed, the frequency fs can be used as a control parameter. Its maximum value has to be limited to fmax=fres/2>fs. FIG. 4 shows a characteristic output voltage wave of the H-bridge 11-14 as well as a basic switching function s(t) generated inside the adaptation circuit 3.

The nominal output voltage Uout may be determined by the number of LEDs connected in series and their voltage drops. It might stay within the voltage range

N2 Uin/(3 N1)<Uout<N2 Uin/N1, whereby N2 represents a number of the secondary windings and N1 represents a number of the primary windings of the transformer 25. If the conditions are fulfilled, two successive sinusoidal half-wave current pulses are drawn from the H-bridge 11-14 for each voltage pulse. The corresponding current I1(t) is presented in FIG. 7 for a certain operation point. Moreover this picture also illustrates the resulting voltage Uc(t) at the series capacitor 27.

Neglecting the magnetization current, the secondary current of the transformer 25 is proportional to the primary current I2=I1 N1/N2. The secondary transformer current is rectified by the diode bridge 21-24. Because of the smoothing capacitor 28 a DC output current is flowing in the load 6 which is equal to the average value of the rectified secondary transformer current.

The output current and thus the LED current is proportional to the frequency and the input voltage: Iout=2 Uin N1 fs/(Zres π N2 fres). Since the input voltage Uin varies with the mains voltage and because of a voltage ripple caused by a small further smoothing capacitor 46, the frequency fs may be adapted in such a way that the product of Uin and fs and thus the output current Tout is kept relatively constant.

This can be achieved by the adaptation circuit 3 without excluding other circuits such as control circuits. In a first step the unsigned voltage pulses to be generated by the switching function s(t) and the input DC voltage Uin are low pass filtered (e.g. by a RC network). The resulting DC voltage is proportional to the voltage frequency product. This voltage is converted into a current via the converter 33 and is compared with a reference current and the difference sets the operating frequency fs via the controller 35. Thereto, the controller 35 controls the voltage controlled oscillator 36 that generates fs and that triggers the monoflop 37 that generates the control signal s(t) with pulses having a pulse width ton etc. Preferably, but not exclusively, ton=1/(2 fres). The turn on delay circuits 54a, 54b, 55a, 55b introduce a time delay tdon for avoiding a short circuit in the H-bridge 11-14.

Possible modifications are:
Instead of MOSFETs any other transistor technology may be used.
The smoothing capacitor 28 connected in parallel to the LEDs can be omitted and the series capacitor 27 may be located at a primary and/or a secondary transformer side.
The free-wheel path of the H-bridge 11-14 could always be realized by turning on 12 and 14. In this case the turn on time of the upper transistors 11 and 13 is restricted to the constant pulse width ton which is an advantage.

The input rectifier may be realized by a power factor correction or PFC rectifier circuit.
The driver may be realized without a transformer 25 but with an inductor such as a series choke for forming the resonant topology.
The full bridge output rectifier 21-24 could also be replaced by a combination of split output winding plus only two diodes with the benefit of saving two diodes and having less diode forward conduction losses (but at the price of needing a second winding and perhaps getting asymmetric LED peak currents for the positive and negative transformer input voltage).

This invention might be used for wall flooding, LCD backlighting and general illumination, without excluding other applications with loads in the form of LEDs or in the form of non-LEDs.

Summarizing, adaptation circuits 3 for controlling conversion circuits 1-2 for converting input signals into pulse signals and for converting pulse signals into output signals are provided with generators 30 for generating control signals in dependence of input signals and (basic idea) with compensation circuits 71-72, 81-83 for adjusting the generators 30 in dependence of input information for increasing a stability of output signals, to be able to supply relatively constant output signals to loads 6. The adaptation circuits 3 may reduce dependencies between input signals and output signals and may generate control signals independently from output signals to avoid feedback loops. Input signals may be input voltages, output signals may be output currents, and input information may comprise input voltages and nominal input voltages for compensating for variations of input voltages or may comprise nominal output voltages and input currents proportional to output voltages for compensating for variations of output voltages.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Adaptation circuit for controlling a conversion circuit for converting an input signal into a pulse signal and for converting the pulse signal into an output signal, the adaptation circuit comprising:
an input for receiving the input signal,
a generator for generating a control signal based, at least in part, on the input signal and independently from the output signal,
an output for supplying the control signal to the conversion circuit, and
a compensation circuit for adjusting the generator based, at least in part, on an input information for increasing a stability of the output signal.

2. (canceled)

3. Adaptation circuit as defined in claim 1, wherein the input signal is an input voltage and the output signal is an output current and the input information comprises the input voltage and a nominal input voltage for compensating for variations of the input voltage.

4. Adaptation circuit as defined in claim 3, wherein the generator comprises
a multiplier for multiplying the input voltage and the control signal,
a low pass filter for low pass filtering a multiplier output signal,
a converter for converting a low pass filter output signal into a converted low pass filter output signal,
a unit for determining a difference between the converted low pass filter output signal and a weighted difference between the input voltage and the nominal input voltage,
a controller for receiving a unit output signal,
a voltage controlled oscillator for receiving a controller output signal, and
a monoflop for receiving a voltage controlled oscillator output signal and for generating the control signal.

5. Adaptation circuit as defined in claim 1, wherein the input signal is an input voltage and the output signal is an output current and the input information comprises a nominal output voltage and an input current that is proportional to an output voltage for compensating for variations of the output voltage.

6. Adaptation circuit as defined in claim 5, wherein the generator comprises
a multiplier for multiplying the input voltage and the control signal,
a low pass filter for low pass filtering a multiplier output signal,
a converter for converting a low pass filter output signal into a converted low pass filter output signal,
a unit for determining a difference between the converted low pass filter output signal and a weighted difference between the nominal output voltage and a peak detected input current,
a controller for receiving a unit output signal,
a voltage controlled oscillator for receiving a controller output signal, and
a monoflop for receiving a voltage controlled oscillator output signal and for generating the control signal.

7-8. (canceled)

9. Method for controlling a conversion circuit for converting an input signal into a pulse signal and for converting the pulse signal into an output signal, which method comprises the steps of:
receiving the input signal,
generating a control signal based, at least in part of, the input signal and independently from the output signal,
supplying the control signal to the conversion circuit, and
adjusting the generating in dependence of input information for increasing a stability of the output signal.

10. (canceled)
